(19) United States
(12) Patent Application Publication
(10) Pub. No.: US 2013/0105246 A1
(43) Pub. Date: May 2, 2013

(54) ENERGY ABSORBER

(71) Applicant: D B INDUSTRIES, INC., Red Wing, MN (US)

(72) Inventors: David A. Schlangen, Red Wing, MN (US); Judd J. Perner, Red Wing, MN (US)

(73) Assignee: D B INDUSTRIES, INC., Red Wing, MN (US)

(21) Appl. No.: 13/656,119

(22) Filed: Oct. 19, 2012

Related U.S. Application Data
(60) Provisional application No. 61/552,498, filed on Oct. 28, 2011.

(51) Int. Cl. A62B 35/04; B32B 7/08

(52) U.S. Cl. 182/241; 112/440

(57) ABSTRACT

An energy absorber is provided that includes a first energy absorbing webbing, a second energy absorbing webbing and a plurality of connecting fibers. The plurality of connecting fibers couple at least a portion of the first energy absorbing webbing to at least a portion of the second energy absorbing webbing. The plurality of connecting fibers are configured and arranged to form at least two different tear strength areas in the at least one portion of the first energy absorbing webbing coupled to the at least one portion of the second webbing. The at least two different tear strength areas having select tear strengths.

### CROSS-REFERENCE TO RELATED APPLICATIONS

This Application claims priority to U.S. Provisional Application Ser. No. 61/552,498 same title herewith, filed on Oct. 28, 2011, which is incorporated in its entirety herein by reference.

### BACKGROUND

To protect workers that have to work at heights, lifelines coupled to safety harnesses donned by a worker are typically used. If a fall event occurs, the lifeline coupled to a support structure limits the fall of the worker. Injury to the worker can occur when the fall distance, before the lifeline becomes taut, is significant. Energy absorbers have been added to lifeline systems to provide a less abrupt stop to help reduce or prevent injuries. An energy absorber absorbs some of the kinetic energy of the falling body.

For the reasons stated above and for other reasons stated below which will become apparent to those skilled in the art upon reading and understanding the present specification, there is a need in the art for an effective and efficient and energy absorbing system that fits in a relatively small package.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, an energy absorber is provided. The energy absorber includes a first energy absorbing webbing, a second energy absorbing webbing and a plurality of connecting fibers. The plurality of connecting fibers couple at least a portion of the first energy absorbing webbing to at least a portion of the second energy absorbing webbing. The plurality of connecting fibers are configured and arranged to form at least two different tear strength areas in the at least one portion of the first energy absorbing webbing coupled to the at least one portion of the second webbing. The at least two different tear strength areas having select tear strengths.

In another embodiment, another energy absorber is provided. The energy absorber includes a first energy absorbing webbing, a second energy absorbing webbing, a plurality of connecting fibers and first and second attaching webbings. The first energy absorbing webbing has a length that is defined between a first end and a second end. The first energy absorber further has a first mid portion that is centrally located between the first end and the second end. The second energy absorbing webbing is positioned along the length of the first energy absorber. The second energy absorbing webbing has a length that is defined between a first and second end. The second energy absorbing webbing has a second mid portion that is centrally located between the first and the second end of the second energy absorbing webbing. The second mid portion of the second energy absorbing webbing is aligned with the first mid portion of the first energy absorbing webbing. The plurality of connecting fibers connect the first energy absorbing webbing to the second energy absorbing webbing. In particular, the plurality of connecting fibers connect the first energy absorbing webbing to the second energy absorbing webbing between respective first ends of the first and second energy absorbing webbings and the respective mid portions and between respective second ends of the first and second energy absorbing webbings and the respective mid portions. The plurality of connecting fibers are configured and arranged to form at least two different tear strength areas in the first and second energy absorbing webbings. The first attaching webbing is coupled to the first mid portion of the first energy absorber and the second attaching webbing is coupled to the second mid portion of the second energy absorber.

In still another embodiment, a lifeline system is provided. The lifeline system includes a lifeline and an energy absorber. The lifeline is configured and arranged to be coupled between a support structure and a safety harness. The lifeline includes a back strap portion and an energy absorber system. The energy absorbing system includes a first webbing, a second webbing, a first attaching webbing, a second attaching webbing and connecting fibers. The second webbing is coupled along a first webbing length of the first webbing. The first attaching webbing is coupled between a first mid portion of the first webbing and a first end of the back strap portion of the lifeline. The second attaching webbing is coupled between a second mid portion of the second webbing and a second end of the back strap portion of the lifeline. The second mid portion of the second webbing is aligned with the first mid portion of the first webbing forming first and second webbing connection portions of generally equal lengths on either side of the respective first and second mid portions of the first and second webbings.

The connecting fibers couple the first webbing to the second webbing. The connection fibers form a first tear strength area, a second tear strength area and a transition tear area in each of the first and second webbing connection portions of the first and second webbings. The first tear strength area has a tear strength less than the tear strength of the second tear strength area. The transition tear strength area has a tear strength between the first tear strength and the second tear strength. Each first tear strength area is positioned adjacent an associated first and second mid portion of the first and second webbings. The transition tear strength area is further positioned between the first and second tear strength areas.

### BRIEF DESCRIPTION OF THE DRAWINGS

The present invention can be more easily understood and further advantages and uses thereof will be more readily apparent, when considered in view of the detailed description and the following figures in which:

FIG. 1 is a side perspective view of a portion of a lifeline assembly of one embodiment of the present invention;

FIG. 2 is a front view of an energy absorbing system of one embodiment of the present invention;

FIG. 3 is an unassembled view of the lifeline assembly of FIG. 1;

FIG. 4A is a front view of an energy absorbing webbing assembly of one embodiment of the present invention;

FIG. 4B is a front view of another embodiment of an energy absorbing webbing assembly of the present invention;

FIG. 5A is a side view of another embodiment of an energy absorbing system of the present invention;

FIG. 5B is a side view of the energy absorbing system of FIG. 5A shown during partial deployment; and

FIG. 5C is a side view of the energy absorbing system of FIG. 5A shown during full deployment.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

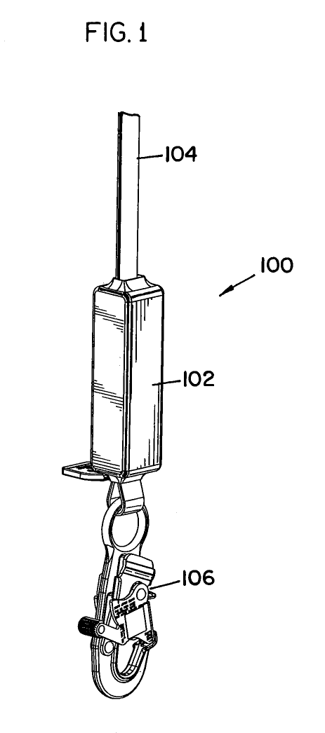

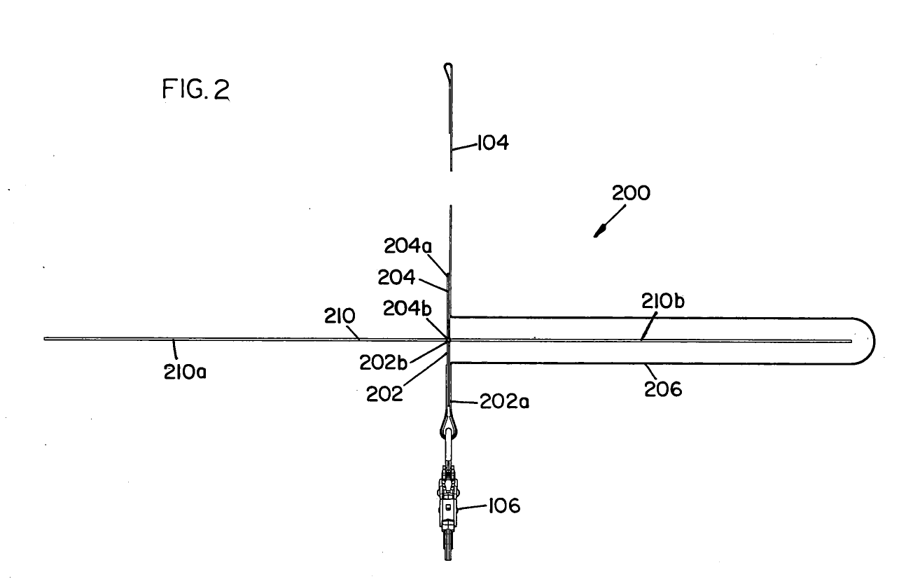

Embodiments of the present invention provide an energy absorbing system to reduce or prevent an injury when an associated lifeline becomes taut during a fall event. Embodiments of the present invention absorb energy by tearing apart a pair of webbings that are connected together. The pair of webbings are coupled together by connecting fibers. In one embodiment, the energy absorber is a two phase energy absorber having at least two different tear strength areas. A side perspective view of a portion of a lifeline assembly 100 of one embodiment is illustrated in FIG. 1. The lifeline assembly 100 includes a lifeline 104 that would be attached to a support structure and a connector 106 that would be connected to a safety harness donned by a user. The lifeline assembly 100 could be a self retracting lifeline or other suitable lifeline assembly. The lifeline assembly 100 also includes an energy absorbing system 200 that is contained in the energy absorbing housing 102. The front view of FIG. 2 illustrates the energy absorbing system 200 of an embodiment. The energy absorbing system 200 includes a first attachment webbing 202 and a second attachment webbing 204. The first attachment webbing 202 has a first end 202a that is secured to connector 106. A second end 202b of the first attachment webbing 202 is coupled to an energy absorbing webbing 210 which is further described in detail below. Secured to the first attachment webbing 202 proximate the connector 106 is a back strap portion 206 of the lifeline 104. The second attachment webbing 204 includes a first end 204a that is coupled to the back strap portion 206 of the lifeline 104. The second attachment webbing 204 further includes a second end 204b that is coupled to the energy absorbing webbing 210 as described below. The energy absorbing webbing 210 includes a first side 210a and a second side 210b.

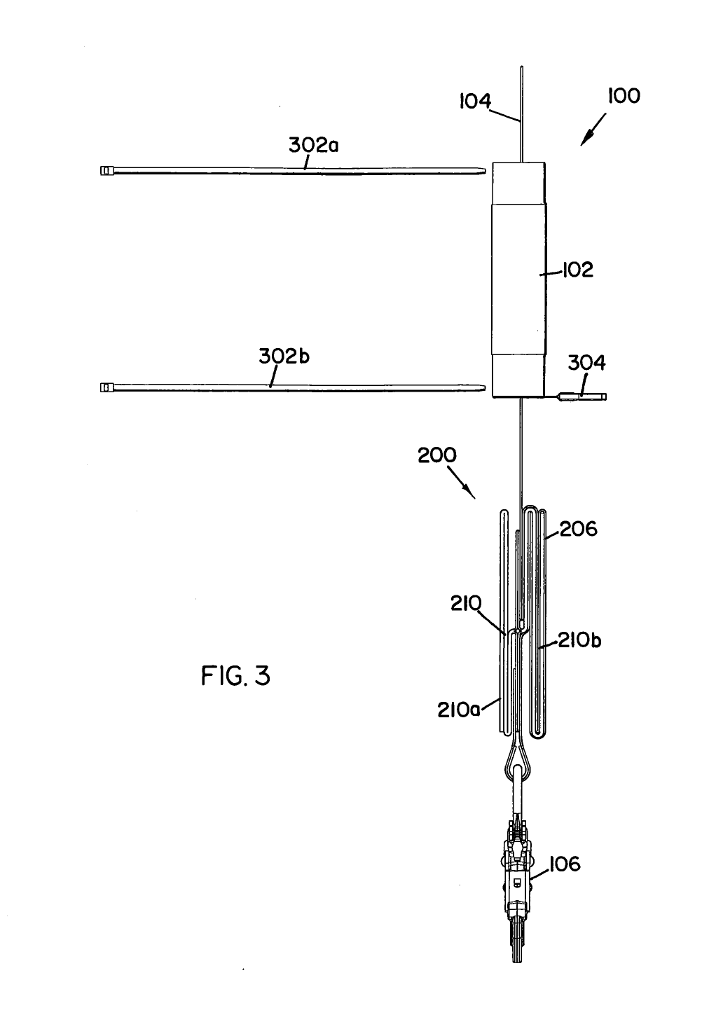

FIG. 3 illustrates a front view of an unassembled lifeline assembly 100. As illustrated, the portions of the energy absorbing system 200 are folded up to be received in the housing 102. As illustrated, the energy absorbing system 200 includes the energy absorbing webbing 210 and the back strap portion 206 of the lifeline 104. Once the energy absorbing system 200 is folded up, the housing 102 is positioned to cover the energy absorbing system 200. One advantage of the present energy absorbing system 200 is that it can be provided in a relatively small envelope. Hence, embodiments provide a relatively small energy absorbing system that is unlikely to interfere with the activities of a worker that is coupled to the lifeline.

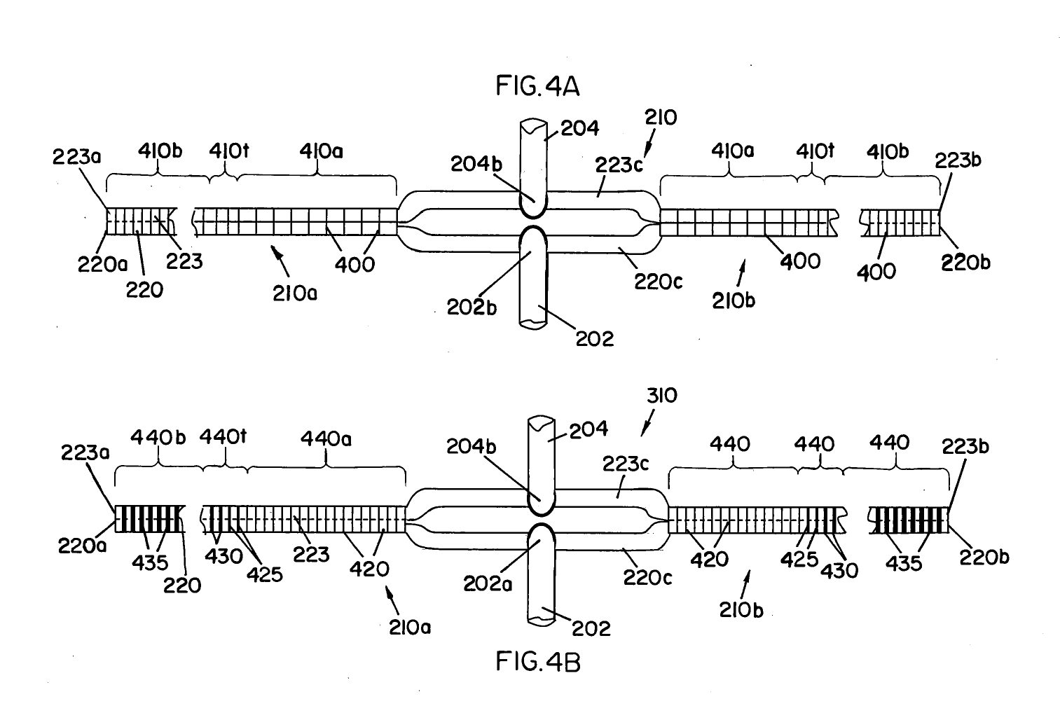

Referring to FIGS. 4A and 4B, embodiments of the energy absorbing webbing 210 and 310 are illustrated. In the embodiment of FIG. 4A, energy absorbing webbing 210 is illustrated. The energy absorbing webbing 210 includes a first energy absorbing webbing 220 and a second energy absorbing webbing 223. The first webbing 220 has a length that extends between a first end 220a and a second end 220b. The second webbing 223 has a length that extends between a first end 223a and a second end 223b. In an embodiment, the lengths of the webbing 220 and 223 are generally equal. The webbings 220 and 223 are positioned against each other and are held together by warp fibers 400 (or cross stitching 400). Mid portion 220c and 223c of each of the webbings 220 and 223 that are centrally located between the respective ends 220a, 220b and 223a, 223b are not connected together. The second end 202b of the first attaching web 202 is coupled to the mid portion 220c of the first webbing 220 and the second end 204b of the second attaching webbing 204 is coupled to the mid portion 223c of the second webbing 223. In one embodiment, as illustrated in FIG. 2, the respective mid portions 220c and 223c are folded up upon themselves. In this embodiment, the respective second end 202b of the first attachment webbing 202 is sewn onto the folds of mid portion 220c to connect first attachment webbing 202 to the first webbing 220 and the second end 204b of the second attaching webbing 204 is sewn onto the folds of mid portion 223c to connect the second attaching webbing 204 to the second webbing 223.

As illustrated by the arrow A in FIGS. 4A and 4B, during a fall event the mid portions 220c and 223c are pulled away from each other. As the webbings 220 and 223 are being pulled apart from each other, the fibers 400 that hold the webbings 220 and 223 together are broken or pulled out from the respective webbings 220 and 223 thereby absorbing energy as they break or separate. In embodiments, each side 210a and 210b of the energy absorbing webbing 210 is divided up into areas of different tearing strengths 410a, 410t and 410b. The sides 210a and 210b can be referred to as a first webbing connector portion 210a and a second webbing connector portion 210b.

The differing tear strength areas 410a, 410t and 410b are designed to control the rate of tear while maintaining the integrity of the energy absorption system during a fall event. In one embodiment, the tear strength area 410a tears apart at less of a force than tear strength area 410b. Tear strength area 410t provides a transition between the tear strength of area 410a and area 410b. The transition area 410t helps prevent either of the first and second webbings 223 and 220 from themselves ripping apart which could happen at an abrupt tear strength change point. The tear strengths in the tear strength areas 410a, 410t and 410b can vary depending on the intended use and the desired energy absorption of the device. In one example embodiment, the force needed to tear the webbings 223 and 220 apart from each other in tear strength area 410a is approximately in a range of 500 lbs to 900 lbs, while the force needed to tear the webbings 223 and 220 apart from each other in tear strength area 410b is in a range of approximately 1400 lbs to 1800 lbs. In one embodiment, the force needed to tear the webbings 223 and 220 apart from each other in tear strength area 410a is approximately 500 lbs, while the force needed to tear the webbings 223 and 220 apart from each other in tear strength area 410b is approximately 1600 lbs. In another embodiment, the force needed to tear the webbings 223 and 220 apart from each other in tear strength area 410a is under 800 pounds while the force needed to tear the webbings 223 and 220 apart from each other in tear strength area 410b is under 1700 pounds. Further, in an example embodiment, webbings 220 and 223 have a width of approximately 1.35 inches with the mid portions 220c and 223c of the webbing being approximately 6 inches long and each side 210a and 210b of the energy absorbing webbing 210 having a first tear strength area 410a length of approximately 5 inches, a transition tear strength area 410t of approximately 0.75 of an inch and a second tear strength area 410b length of approximately 15.375 inches. The width of the webbings 223 and 220 and the lengths of the tear strength areas 410a, 410t and 410b are selected depending on the application. Moreover, the tear strengths can be selected to achieve a desired outcome or to conform to standards set by OSHA, ANSI or any other regulating body.

Different methods can be used to achieve the different tear strength areas 410a, 410t and 410b. For example, referring to FIG. 4A, the different tear strength is achieved by varying the distance between fibers (cross stitches). As illustrated in FIG. 4A, the first tear strength area 410a has a greater space between fibers 400 than the fibers 400 in the second tear strength area 410b. That is, the second tear strength area 410b has a greater fiber density than the first tear strength area 410a. The transition tear strength area 410t transitions from the fiber density in the first tear strength area 410a to the fiber density in the second tear strength area 410b. Another example embodiment is illustrated in FIG. 4B. In this embodiment, the varying tear strength areas 440a 440b and 440t are created by the use of different fibers 420, 425, 430 and 435 interconnecting the webbings 220 and 223 that have differing fiber tear strengths. This can be accomplished by using fibers of different diameters or by using fibers of different material. As FIG. 4B of this embodiment illustrates, each of the sides 210a and 210b of the energy absorbing webbing 310 includes fibers 420 in the first tear strength area 440a and fibers 435 in the second tear strength area 440b. Fibers 425 and 430 having tear strengths between the fibers of the first tear strength area 440a and the second tear strength area 440b are located in the transition tear strength area 440t. Hence, there are several methods to vary the strength of the respective tear strength areas.

In use, if a fall event should occur, once the lifeline 104 becomes taut, the second attachment webbing 204 coupled to the mid portion 223c of the second energy absorbing webbing 223 holds the mid portion 223c at a relatively static location in relation to a support structure. The first attachment webbing 202 that is coupled to the mid portion 220c of the second energy absorbing webbing 220 pulls the mid portion 220c down with the falling of the safety harness donned by the worker. The first and second energy absorbing webbings 220 and 223 are then pulled apart starting in the respective first tear areas 410a, 440a of the respective first and second sides 210a and 210b of the energy absorbing webbing 210. The tearing or pulling of the fibers 400, 420 to separate the first and second webbings 220 and 223 from each other absorbs energy. If the fall event has not been completed at the end of the respective first tear strength area 410a, 440a, the first and second webbings 220 and 223 begin to separate in the respective transition tear strength areas 410t, 440t. Since, the tear strength is higher in the transition tear strength area, more energy will be absorbed. If the fall event has still not been completed at the end of the transition tear strength areas 410t, 440t, the first and second webbing's 220 and 223 begins to separate in the respective second tear strength area 410b, 440b. Since, the tear strength is even higher in the second tear strength area 410b, 440b even more energy is absorbed. If the fall event is still not completed at the end of the respective second tear strength area 410b, 440b, the first and second energy absorbing webbings 220 and 223 will be totally separated. However, since the back strap portion 206 of the lifeline 104 is also coupled between the first attachment webbing 202 and the second attachment webbing 204 (as illustrated in FIG. 2), the lifeline 104 will remain attached between the support structure and the connector 106 to the harness donned by the worker. Hence, even in situations where more energy is needed to be absorbed than can be provided by the energy absorbing system 200 the lifeline will still be attached between the support structure and the worker to help prevent harm to the worker during a fall event. In one embodiment the tear strength areas 410a and 440a are designed to tear apart during a typical fall event and the tear strength areas 410b and 440b are designed to tear apart during a severe fall event.

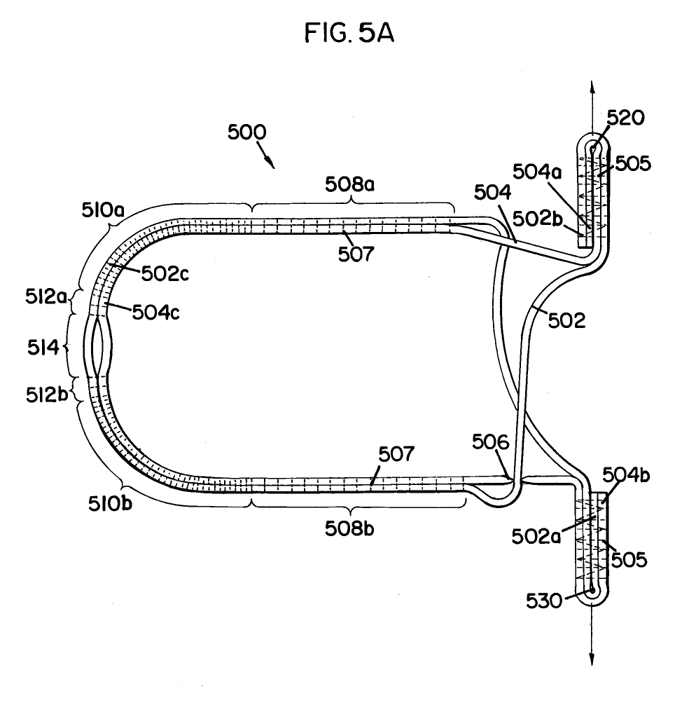

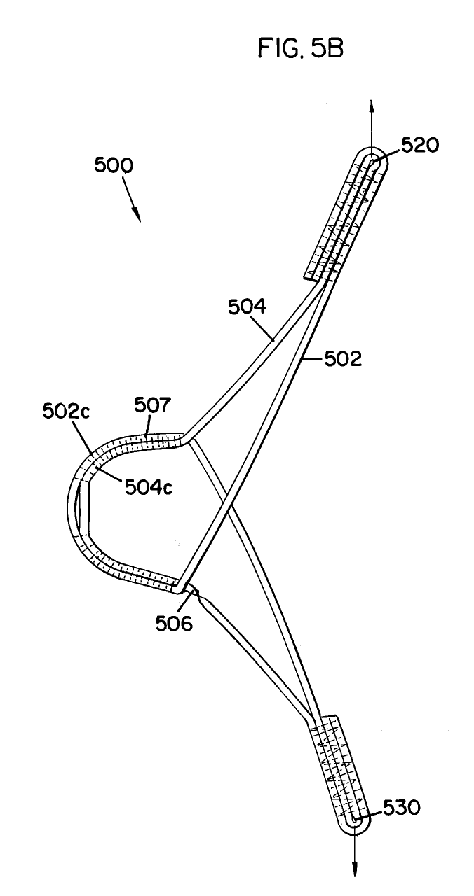

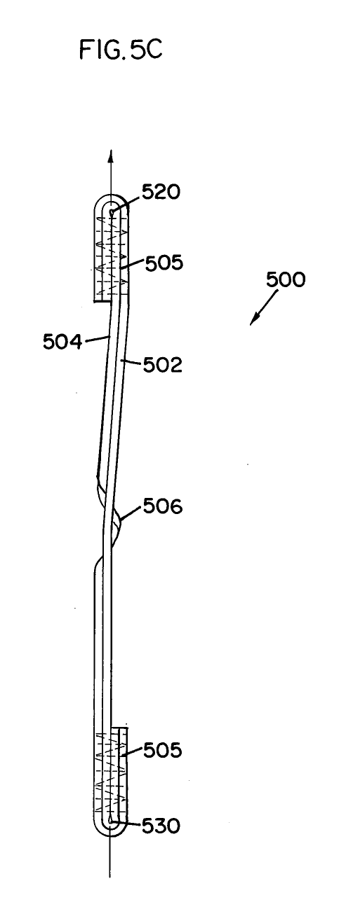

Referring to FIG. 5A another embodiment of an energy absorbing system 500 is provided. This embodiment eliminates the need for a back strap as discussed further below. Energy absorbing system 500 is related to commonly assigned U.S. Patent Application having Ser. No. 13/463,986 entitled “Energy Absorber” which is herein incorporated in its entirety by reference. In this embodiment, a first and a second webbing 502 and 504 are used for the energy absorbing system 500. A first end 502a of the first webbing 502 and a second end 504b of the second webbing 504 are folded back on itself and coupled by stitching 505 to form a first connection point 520. Similarly, a second end 502b of the first webbing 502 and a first end 504a of the second webbing 504 are folded back on itself and coupled by stitching 505 to form a second connection point 530. The first connection point 520 can be used to be coupled to a support structure or a self retracting lifeline that is coupled to a support structure. The second connection point 530 can be used to be coupled to a safety harness donned by a user. A mid portion 502c and 504c of the first and second webbings 502 and 504 are coupled together by tear fibers 507 (or tear yarns). As illustrated, the second webbing 504 includes a twist 506 to pass around the first webbing 502. Also similar to the embodiments discussed above, this embodiment includes different tear strength areas 508a, 508b, 510a, 510b, 512a and 512b.

In this embodiment, a central non-connected area 514 is included. In one embodiment, the first tear strength areas 512a and 512b have a tear strength that is less than the tear strength of the second tear strength areas 510a and 510b. Moreover, the third tear strength areas 512a and 512b that lead to the central non-connected area 514 have a tear strength that is less than the second tear strength areas 510a and 510b. The third tear strength areas 512a and 512b are ramped down sections to the central non-connected area 514. These ramped down sections 512a and 512b prevent instantaneous webbing shock in the first and second webbings 502 and 504 as the webbings 502 and 504 become separated. Webbing shock could damage the overall strength of the strip of webbing 502 and 504. The mid portion 502c and 504c of the first and second webbings 502 and 504 can be folded up or rolled up and positioned in an energy absorbing housing, such as energy absorbing housing 102 shown in FIG. 1.

FIG. 5B illustrates the energy absorbing system 500 in a partial deployment configuration such as would occur during a fall event. As illustrated in FIG. 5B, the mid portion 502c and 504c of the first and second webbings 502 and 504 has started to pull apart from each other therein absorbing energy. FIG. 5C illustrates the energy absorbing system 500 in full deployment. As illustrated, because of the configuration of the first and second webbings 502 and 504 maintain a connection between the first and second connecting points 520 and 530, there is no need for a back strap. This configuration therein provides a more compact energy absorbing system 500. In one embodiment, without a back strap, the strips of webbing 502 and 504 provide a tensile strength of over 8,500 lbs post deployment. Moreover, the dual webbings 502 and 504 provide an additional strap over a typical system with a back strap to provide an added level of safety. Hence, even if one strip of webbing 502 or 504 fails during a fall event, the other strip of webbing 502 or 504 will still provide the back strap function which is to retain a connection between a support surface and a safety harness donned by the worker after the energy absorber is spent.

Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention. Therefore, it is manifestly intended that this invention be limited only by the claims and the equivalents thereof.

1. An energy absorber comprising:
a first energy absorbing webbing;
a second energy absorbing webbing; and
a plurality of connecting fibers coupling at least a portion of the first energy absorbing webbing to at least a portion of the second energy absorbing webbing, the plurality of connecting fibers configured and arranged to form at least two different tear strength areas in the at least one portion of the first energy absorbing webbing coupled to the at least one portion of the second webbing, the at least two different tear strength areas having select tear strengths.

2. The energy absorber of claim 1, further comprising:
the first energy absorbing webbing having a first length defined between a first end and a second end, the first energy absorbing webbing having a mid portion centrally located between the first end and the second end of the first energy absorbing webbing;
the second energy absorbing webbing having a second length defined between a first end and a second end, the second energy absorbing webbing having a mid portion centrally located between the first end and a second end of the second energy absorbing webbing, the lengths of the first energy absorbing webbing and the second energy absorbing webbing being generally equal, the first energy absorbing webbing positioned next to the second energy absorbing webbing such that the mid portion of the first energy absorbing webbing is aligned with the mid portion of the second energy absorbing webbing; and
the plurality of connecting fibers positioned along first lengths of the first and second energy absorbing webbings between the first ends of the respective first and second energy absorbing webbings to the respective mid portions of the first and second energy absorbing webbings and along second lengths of the first and second energy absorbing webbings between the second ends of the respective first and second energy absorbing webbings to the respective mid portions of the first and second energy absorbing webbings.

3. The energy absorber of claim 1, further comprising:
the coupling of the first energy absorbing webbing to the second energy absorbing webbing having varying tear strength areas along the respective first and second lengths.

4. The energy absorber of claim 2, wherein along each of the first and second lengths the first and second energy absorbing webbings include a first tear strength area, a second tear strength area and a transitional tear strength area positioned between the first tear strength area and the second tear strength area.

5. The energy absorber of claim 4, wherein the first tear strength area is positioned proximate the mid portions of the first and second energy absorbing webbings, the first tear strength area having a tear strength that is less than the tear strength of the second tear strength area.

6. The energy absorber of claim 5, wherein the tear strength of the first tear strength area is within the range of 500 lbs to 900 lbs, the tear strength of the second tear strength area is in the range of 1400 lbs to 1800 lbs and the tear strength of the transitional tear strength area varies from approximately the tear strength of the first tear strength area to approximately the second tear strength area.

7. The energy absorber of claim 1, wherein the varying tear strength areas are formed by at least one of, selectively spacing the connecting fibers, varying the thickness of the connecting fibers and varying the material of the connecting fibers.

8. The energy absorber of claim 2, further comprising:
a first attaching webbing coupled to the mid portion of the first energy absorbing webbing, the first attaching webbing operationally coupled to a safety harness connector; and
a second attaching webbing coupled to the mid portion of the second energy absorbing webbing, the second attaching webbing operationally coupled to a lifeline.

9. The energy absorber of claim 8, further comprising:
a back strap portion coupled to the first attaching webbing and the second attaching webbing.

10. The energy absorber of claim 1, further comprising:
the first energy absorbing webbing having a first end portion and an opposed second end portion; and
the second energy absorbing webbing having a first end portion and an opposed second end portion, the first end portion of the first energy absorbing webbing coupled to the second end portion of the second energy absorbing webbing and the second end of the first energy absorbing webbing coupled to the first end of the second energy absorbing webbing.

11. An energy absorber comprising:
a first energy absorbing webbing having a length defined between a first end and a second end, the first energy absorber having a first mid portion centrally located between the first end and the second end of the first energy absorbing webbing;
a second energy absorbing webbing positioned along the length of the first energy absorber, the second energy absorbing webbing having a length defined between a first and second end, the second energy absorbing webbing having a second mid portion centrally located between the first and the second end of the second energy absorbing webbing, the second mid portion of the second energy absorbing webbing being aligned with the first mid portion of the first energy absorbing webbing; and
a plurality of connecting fibers connecting the first energy absorbing webbing to the second energy absorbing webbing, the plurality of connecting fibers connecting the first energy absorbing webbing to the second energy absorbing webbing between respective first ends of the first and second energy absorbing webbings and the respective first and second mid portions and between respective second ends of the first and second energy absorbing webbings and the respective mid portions, the plurality of connecting fibers configured and arranged to form at least two different tear strength areas in the first and second energy absorbing webbings.

12. The energy absorber of claim 11, wherein the at least two different tear strength areas further comprise:
a first tear strength area having a first tear strength;
a second tear strength area having a second tear strength; and
a transition tear strength area having a tear strength between the first and second tear strengths.

13. The energy absorber of claim 12, wherein each of a length of the first and second energy absorbing webbings between respective first ends of the first and second energy absorbing webbings and the respective mid portions of the first and second energy absorbing webbings and a length of the first and second energy absorbing webbings between respective second ends of the first and second energy absorbing webbings and the respective mid portions of the first and second energy absorbing webbings includes the first tear strength area, the second tear strength area and the transition tear strength area.

14. The energy absorber of claim 13, wherein the first tear strength is less than the second tear strength.

15. The energy absorber of claim 11, wherein the two different tear strength areas are formed by at least one of varying connection fiber density, varying connection fiber size and varying connection fiber material.

16. The energy absorber of claim 11, further comprising:
a first attaching webbing coupled to the first mid portion of the first energy absorber; and
a second attaching webbing coupled to the second mid portion of the second energy absorber.

17. The energy absorber of claim 16, further comprising:
a back strap portion coupled between the first attaching webbing and the second attaching webbing.

18. The energy absorber of claim 11, further comprising:
the first end of the first energy absorbing webbing and the second end of the second energy absorbing webbing folded over on itself and coupled together to form a first connection point and the second end of the first energy absorbing webbing and the first end of the second energy absorbing webbing folded over on itself and coupled together to form a second connection point.

19. A lifeline system comprising:
a lifeline configured and arranged to be coupled between a support structure and a safety harness, the lifeline including a back strap portion; and
an energy absorber system including:
a first webbing,
a second webbing coupled along a first webbing length of the first webbing,
a first attaching webbing coupled between a first mid portion of the first webbing and a first end of the back strap portion of the lifeline,
a second attaching webbing coupled between a second mid portion of the second webbing and a second end of the back strap portion of the lifeline, the second mid portion of the second webbing aligned with the first mid portion of the first webbing forming first and second webbing connection portions of generally equal lengths on either side of the respective first and second mid portions of the first and second webbings; and
connecting fibers coupling the first webbing to the second webbing, the connection fibers forming a first tear strength area, a second tear strength area and a transition tear area in each of the first and second webbing connection portions of the first and second webbings, the first tear strength area having a tear strength less than the tear strength of the second tear strength area, the transition tear strength area having a tear strength between the first tear strength and the second tear strength, each first tear strength area positioned adjacent an associated first and second mid portion of the first and second webbings, the transition tear strength area being positioned between the first and second tear strength areas.

20. The lifeline system of claim 19, further comprising:
a safety harness connector coupled to the first attaching webbing and the first end of the back strap portion of the lifeline.

21. The lifeline system of claim 19, further comprising:
a housing to contain the back strap portion of the life line and the energy absorber system.

22. The lifeline system of claim 19, wherein the differing tear strengths between the first, second and transition tear strength areas are formed by at least one of, varying connection fiber density, varying connection fiber size and varying connection fiber material.

23. The lifeline system of claim 19, wherein the first tear strength area has a first tear length, the second tear strength area has a second tear length and the third tear strength area has a third tear length of the respective first and second webbing connection portion, at least one of the first, second and third tear lengths being different than the other of the first, second and third tear lengths.
